(19) United States
(12) Patent Application Publication
(10) Pub. No.: US 2016/0146364 A1
(43) Pub. Date: May 26, 2016

(54) CHECK VALVE STRUCTURE

(71) Applicant: NIFCO AMERICA CORP., Canal Winchester, OH (US)

(72) Inventors: Chad BARBER, Canal Winchester, OH (US); Dan ORMSBY, Columbus, OH (US)

(21) Appl. No.: 14/551,738

(22) Filed: Nov. 24, 2014

(51) Int. Cl. F16K 24/04; F16K 15/14

(52) U.S. Cl. CPC F16K 24/04; F16K 15/14

(57) ABSTRACT

A check valve structure includes an engaged portion including a hole for ventilating fluid between one side and another side of the engaged portion, and a hole plug. The hole includes a locking hole and a ventilating hole outwardly circumferentially arranged around the locking hole. The hole plug includes a locking portion inserted in the locking hole to lock the locking portion therein and an outer portion outwardly circumferentially extending from the locking portion to cover the ventilating hole such that the fluid flows in a direction from the one side to the another side, and is prevented from flowing in a direction from the another side to the one side.

### FIELD OF THE INVENTION

The present invention relates to a check valve structure ventilating fluid from an inside to an outside and preventing the fluid and foreign materials from entering from the outside to the inside.

### BACKGROUND ART

As a conventional check valve structure, there is, for example, one shown in Patent Document 1. In the conventional check valve structure, there is an air extractor located under a rear bumper cover. The air extractor includes a base layer defining one aperture, a retainer layer defining another aperture corresponding to the one aperture and disposed on the base layer, and three sealing members covering and substantially sealing the one and the another apertures from an outer surface side of the retainer layer. The base layer is affixed to the retainer layer, and two protruding side portions of an upper portion of each of the three sealing members are sandwiched between the base layer and retaining layer such that the three sealing members are capable of rotating between an opening position and a closed position; thereby, in the conventional check valve structure, a fluid communication between the inside and the outside is provided. The three members are moved in the opening position to ventilate the fluid from the inside to the outside, and moved in the closed position to prevent the fluid and foreign materials from entering in the inside.

However, the conventional check valve is complicated and requires a number of components. Therefore, a size of the conventional check valve is likely to be large, and thereby, it causes a high cost.

Also, as other conventional check valve structures, there are one shown in Patent Document 2 and one shown in Patent Document 3. In the other conventional check valve structures, there is a hole plug or a grommet provided to seal a hole of an engaged portion. The hole plug includes a head portion having a flange portion, a support portion circularly downwardly extending from the head portion, erection portions arranged circumferentially around the support portion, and connecting portions each connecting the support portion and the erection portion. The erection portion has an engagement step portion formed along an outer surface portion thereof, and when the hole plug is inserted in the hole of the engaged portion, a peripheral edge portion of the hole is engaged in the engagement step portion to seal the hole.

The grommet in Patent Document 3 includes a head portion having a central member and a non-insertion portion circularly arranged around the central member, and an insertion portion extending circularly downwardly from the head portion and having a mounting hole circularly formed along an outer surface portion of the insertion portion. When the insertion portion is inserted in the hole of the engaged portion, a peripheral edge portion of the hole is engaged in the mounting portion to seal the hole.

However, in the other conventional structures, the hole plug and the grommet do not have any hole communicated to the outside and thereby, the fluid cannot be ventilated from the inside to the outside through the hole plug or the grommet.

### PRIOR ART DOCUMENT

Patent Document 1: United States Patent Application Publication No. 2014/0106658.
Patent Document 2: Japanese Patent Application Publication No. 2004-162808.
Patent Document 3: Japanese Patent Application Publication No. S61-59067.

### SUMMARY OF THE INVENTION

In the present invention, a check valve structure ventilates fluid from an inside to an outside and prevents fluid and foreign materials from entering from the outside to the inside, and has compact size and is capable of being manufactured at a low cost.

In the invention, a check valve structure comprises an engaged portion including a hole for ventilating fluid between one side and another side of the engaged portion, the hole including a locking hole and a ventilating hole outwardly circumferentially arranged around the locking hole; and a hole plug including a locking portion inserted in the locking hole to lock the locking portion therein and an outer portion outwardly circumferentially extending from the locking portion to cover the ventilating hole. In the check valve structure, the structure is simple and can be easily attached to the engaged portion, wherein the fluid can flow from the one side to the another side, but the fluid and foreign materials can be prevented from flowing in a direction from the another side to the one side.

The outer portion may include a bendable portion having flexibility. In accordance with the flexibility of the bendable portion, the fluid flows from the one side to the another side.

The ventilating hole may include a plurality of holes, and has an outer circumference smaller than that of the outer portion of the hole plug. That is, the outer portion of the hole plug has an outer circumference larger than that of the ventilating hole to cover the ventilating hole at the one side. In accordance with the outer circumference of the outer portion, the fluid is prevented from flowing in the direction from the another side to the one side.

The locking portion may include a plurality of locking pieces, each having a locking claw outwardly protruding from each of the plurality of locking pieces. The locking claw engages the engaged portion and a circumferential gap is formed therebetween. In accordance with the circumferential gap, the fluid is ventilated from the one side to the another side.

The locking claw may have an elasticity to lock the locking portion in the locking hole. In accordance with the elasticity, the locking portion is tightly locked in the locking hole by the elastic reactive force.

The plurality of locking pieces may be spaced from each other to form a space therebetween, and the space is widened in a direction toward a bottom portion of each of the plurality of locking pieces. In accordance with an arrangement of the plurality of locking pieces, the hole plug is made compact with maintaining flow efficiency of the fluid.

The hole plug may further comprise a protruding portion including a plurality of protrusions arranged around the plurality of locking pieces and protruding from a lower surface of the outer portion. The plurality of protrusions contacts the engaged portion outside the locking hole when the hole plug engages the engaged portion.

Also, the locking claw may be arranged at a position not laterally overlapping with each of the plurality of protrusions.

In accordance with the protruding portion including the plurality of protrusions, a circular gap is circularly formed between the lower surface of the outer portion and the engaged portion by an amount equal to a height of the protruding portion in a protruding direction. Therefore, the fluid can be smoothly ventilated through the gap, and the hole plug is made compact with maintaining flow efficiency of the fluid.

The plurality of locking pieces may be circularly arranged at equal intervals, and the plurality of protrusions is arranged circularly outside the plurality of locking pieces at equal intervals so that each of the plurality of protrusions is located between two of the locking claws, respectively. Each of the plurality of protrusions may have a length in a protruding direction shorter than that of the locking claw.

In accordance with an arrangement of the plurality of locking pieces, the plurality of protrusions and the locking claws, the hole plug is made compact with maintaining flow efficiency of the fluid.

The engaged portion may be a panel, and the hole is formed in the panel. Therefore, the check valve structure can be arranged at an exterior of a vehicle, typically under a rear bumper.

### BRIEF DESCRIPTION OF THE DRAWINGS

FIG. 1 is a perspective view of a hole plug in accordance with an embodiment from a top side thereof.

FIG. 2 is a perspective view thereof from a bottom side thereof.

FIG. 3 is a perspective view of an engaged portion in accordance with the embodiment from a bottom side thereof.

FIG. 4 is a bottom view of a check valve structure in accordance with the embodiment wherein the hole plug and the engaged portion are engaged.

FIG. 5 is a perspective view of a hole plug in accordance with a modified embodiment from a bottom side thereof.

FIG. 6 is a bottom view of a check valve structure in accordance with the modified embodiment wherein the hole plug and the engaged portion are engaged.

FIG. 7 is a cross sectional view taken along line 7-7 of FIG. 6.

FIG. 8 is a cross sectional view taken along line 8-8 of FIG. 6.

### DETAILED DESCRIPTION OF DISCLOSED

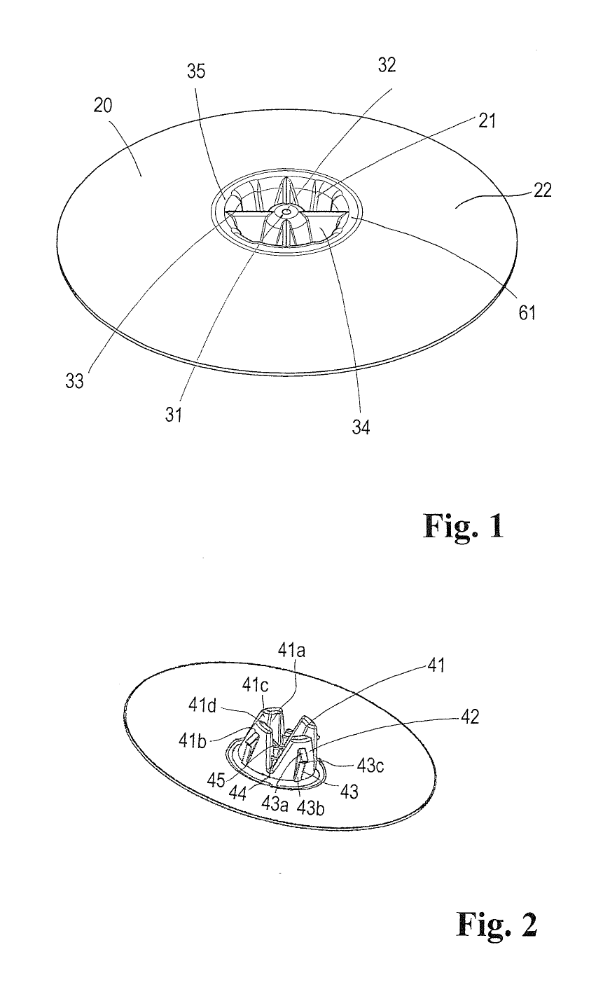

Hereinafter, an embodiment of the present invention will be explained with reference to FIGS. 1 to 8. In the embodiment, a check valve structure 10 is arranged at an exterior of a vehicle, typically under a rear bumper, but is not limited to this. Also, in the embodiment, a check valve structure 10 comprises a hole plug 20 and an engaged portion 50.

Firstly, the hole plug 20 will be explained with reference to FIGS. 1 and 2. The hole plug 20 includes a central portion 21 and an outer portion 22 circularly extending from the center portion 21. The central portion 21 includes a central member 31 having a central axis 32 at a center thereof, and a connecting portion 33 radially extending from the central member 31. In the hole plug of the embodiment shown in FIGS. 1 and 2, the central member 31 has a circular shape, and the connecting portion 33 is arranged in a cross shape around the central axis 32 such that the central portion 21 is split, by the connecting portion 33, into four sections 34 in a circumferential direction of the central portion 21 around the central member 31.

The outer portion 22 includes an inner edge portion 35 arranged along an inner circumference of the outer portion 22, and is bent downwardly in a direction apart from the center portion 21.

The hole plug 20 further includes a locking portion 42 arranged inside the central portion 21. The locking portion 42 is formed with a plurality of locking pieces 41 extending downwardly and inwardly from the inner edge portion 35. The locking piece 41 includes a plurality of surface portions, and the plurality of surface portions includes an inner surface portion 41a extending from the central member 31, an outer surface portion 41b extending from the inner edge portion 35, side surface portions 41c extending from the connecting portion 33, and a bottom surface portion 41d enclosing the inner surface portion 41a, the outer surface portion 41b, and the side surface portions 41c. The inner surface portion 41a is curved such that a distance between the inner surface portion 41a and the outer surface portion 41b becomes narrower in a direction toward the bottom surface portion 41d. The side surface portions 41c connect the inner surface portion 41a and the outer surface portion 41b such that the bottom surface portion 41d is formed as a substantial trapezoid-shape. Also, each of the plurality of surfaces has a shape chamfered with a curved surface around the inner edge portion 35 to avoid a stress concentration.

In the hole plug of the embodiment shown in FIGS. 1 and 2, since the connecting portion 33 is arranged in the cross shape around the central member 31, the locking portion 42 including four locking pieces 41 is formed in the central portion 21. That is, the four locking pieces 41 are formed in the four sections, respectively, and the four locking pieces 41 are circularly arranged at equal intervals.

The four locking pieces 41 has the same shape, respectively, and arranged apart from each other to form a central space defined by the inner surface portions 41a. Also, the four locking pieces 41 are spaced from each other in a circumferential direction to form a side space therebetween, and the side space is widened in a direction toward a bottom surface 41d of each of the locking pieces 41.

The locking piece 41 includes a locking claw 43 arranged on a center portion of the outer surface portion 41b relative to the circumferential direction and outwardly projecting from the outer surface portion 41b. The locking claw 43 includes a first outer surface 43a at a bottom portion side of the locking piece 41, a second outer surface 43b at an upper portion side of the locking piece 41, and a step surface 43c formed between the first outer surface 43a and the second outer surface 43b. The first outer surface 43a is inclined upwardly in a direction from a bottom end of the first outer surface 43a toward the step surface 43c, and the second outer surface 43b is inclined downwardly in a direction from an upper end of the second outer surface 43b toward the step surface 43c. An inclined angle of the first outer surface 43a from the outer surface 41b is larger than that of the second outer surface 43b from the outer surface 41b. Therefore, the step portion 43c is formed therebetween. The locking claw 43 is integrally formed with the locking piece 41.

The locking portion 42 further includes a circumferential rib 44 connecting two locking pieces 41 adjacent to each other in the side space, and a central rib 45 connecting two locking pieces 41 facing each other in the central space. The circumferential rib 44 may connect the upper portions of the two locking pieces 41 relative to an extending direction, and the central rib 45 may connect the center portions of the two inner surfaces 41a relative to the circumferential direction.

A bottom surface of the central rib 45 is located at a position higher than the step surface 43c of the locking claw 43 in a vertical direction, and the circumferential rib 44 has a height substantially same as that of the central rib 45 in the vertical direction. The central rib 45 is not arranged at a portion overlapped with the connecting portions 33.

In the hole plug of the embodiment shown in FIGS. 1 and 2, since the locking portion 42 includes four locking pieces 41, the central rib 45 is arranged in a cross shape around the central axis 32, and each of the locking pieces 41 is connected to other locking pieces 41 through the circumferential ribs 44 and central rib 45. The central rib 45 deviates from the connecting portions 33 by 45 degrees.

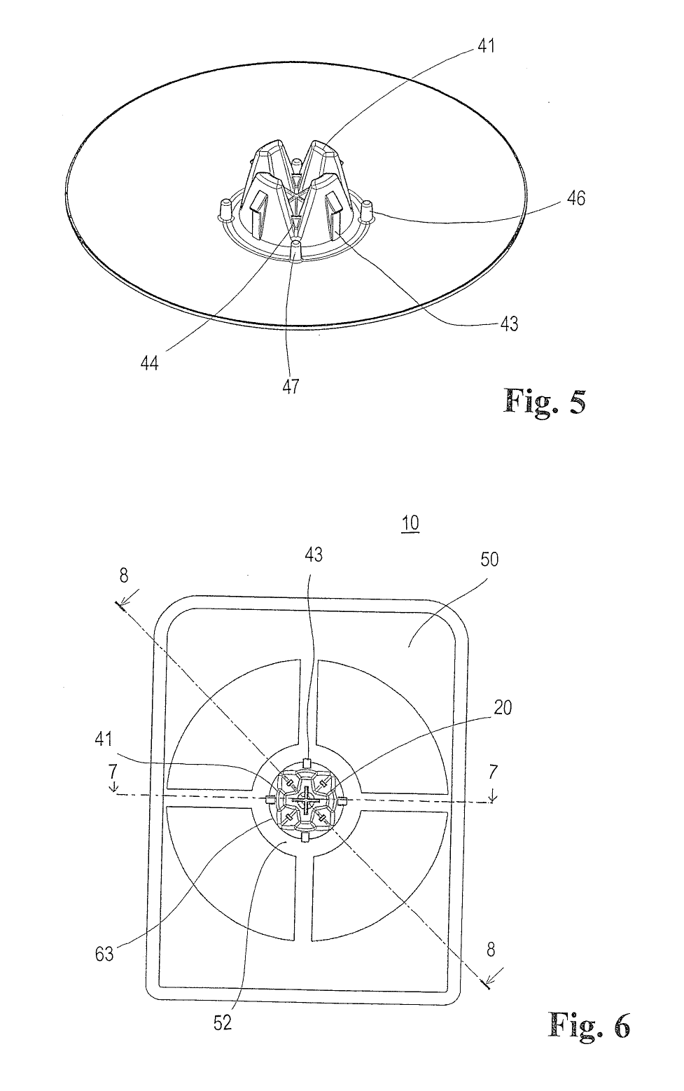

Further, in a hole plug of a modified embodiment shown in FIG. 5, the hole plug 20 includes a protruding portion 46 arranged adjacent to the locking portion 42 and protruding downwardly from a lower surface of the inner edge portion 35 of the outer portion 22 such that a circumferential gap 63, as explained hereafter, is formed surely.

Incidentally, in FIG. 5, the same reference numerals are assigned to parts having the same kind of configuration as the hole plug shown in FIGS. 1 and 2, and their description is omitted. The protruding portion 46 is formed with a plurality of protrusions 47, each being arranged circularly outside the plurality of locking pieces 41. The plurality of protrusions 47 is arranged at positions not laterally overlapping with the locking claws 43. That is, the protrusion 47 is arranged between two of locking claws 43. The protrusion 47 has a height in a protruding direction shorter than that of the locking claw 43.

In in the hole plug of the modified embodiment shown in FIG. 5, the protruding portion 46 includes four protrusions 47 arranged at equal intervals, and the four protrusions 47 are outwardly located at a position facing the circumferential ribs 44, respectively. However, the protruding portion 46 is not limited to this.

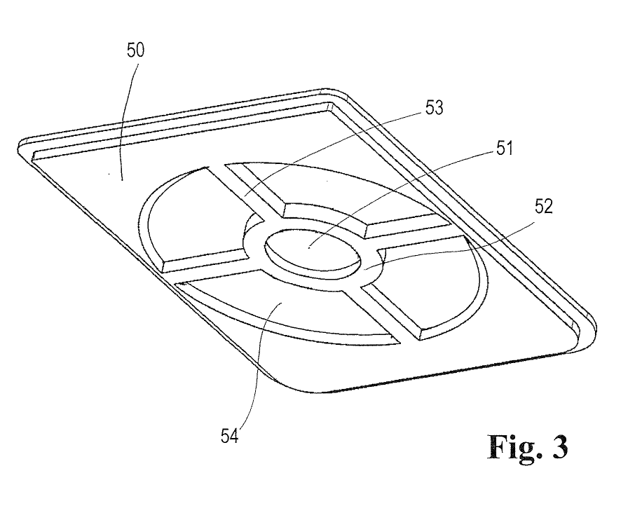

Secondly, the engaged portion 50 will be explained with reference to FIG. 3. The engaged portion 50 includes a locking hole 51, an annular portion 52 surrounding the locking hole 51, ventilating holes 54 circumferentially arranged around the locking hole 51, and coupling portions 53 extending between the ventilating holes 54. The engaged portion may be a panel or any other member of a vehicle. The locking hole 51 and the ventilating holes 54 are defined by the annular portion 52 and coupling portions 53. Typically, the locking hole 51 is formed at a center thereof to lock the hole plug therein, and the ventilating holes 54 are arranged radially around the locking hole 51.

In the engaged portion of the embodiment shown in FIG. 3, the coupling portions 53 are arranged in a cross shape around the locking hole 51 to form four ventilating holes 54, and each of the four ventilating holes 54 has a substantial sector shape such that the four ventilating holes 54 form a circular hole.

Also, in the hole plug of the embodiment shown in FIGS. 1 and 2, and in the hole plug of a modified embodiment shown in FIG. 5, the locking claws 43 and the protruding portion 46 are formed on the hole plug 20. However, the locking claws 43 and the protruding portion 46 may be formed on the engaged portion 50, instead of the hole plug 20. That is, the engaged portion 50 engaging the hole plug shown in FIGS. 1 and 2 or in FIG. 5 may have a protrusion protruding inwardly from an inner circumference of the annular portion 52 toward positions corresponding to the outer surface portion 41b, and the engaged portion 50 engaging the hole plug shown in FIG. 5 may have a protrusion protruding outwardly from an upper surface of the annular portion 52 toward positions corresponding to the lower surface of the inner edge portion 35.

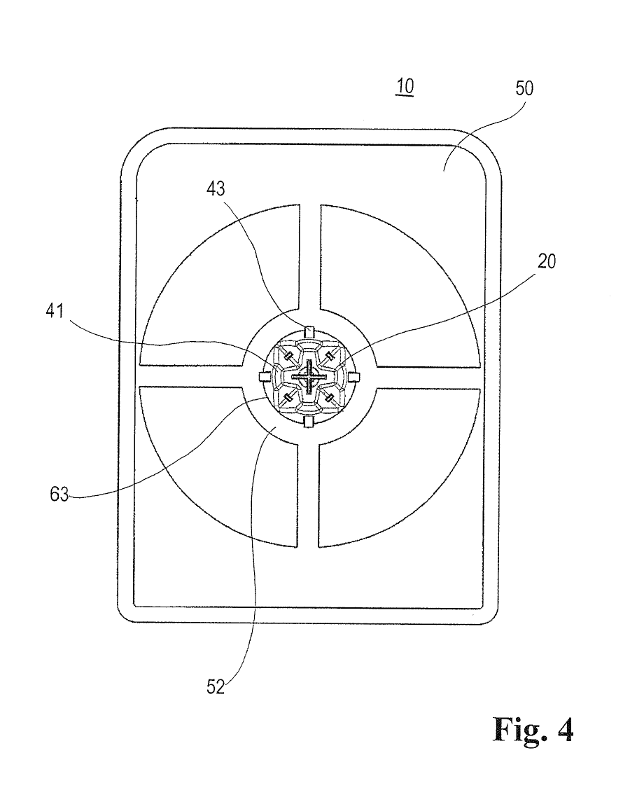

Finally, the check valve structure 10 will be explained with reference to FIGS. 4 and 6-8. As explained above, the check valve structure 10 comprises the hole plug 20 and the engaged portion 50, and the hole plug 20 and the engaged portion 50 are engaged. In the check valve structure 10 of the embodiment, the hole plug 20 is formed integrally by injection molding, and allow the fluid to flow in a direction from the inside to the outside of the engaged portion 50, and to prevent the fluid and the foreign materials from flowing in a direction from the outside to the inside of the engaged portion 50.

The locking portion 42 is inserted in the locking hole 51 such that the hole plug 20 and the engaged portion 50 are engaged. At this time, since the locking portion 42 is formed of an elastic material, the locking portion is deformed elastically to be inserted in the locking hole 51. Also, since the plurality of locking pieces 41 is connected each other through the circumferential ribs 44 and the central rib 45, the plurality of locking pieces 41 is deformed integrally each other, and since the locking claws 43 are also formed of an elastic material, the locking claws 43 are integrally elastically deformed with the plurality of locking pieces 41.

When the locking portion 42 is inserted in the locking hole 51, the step surface 43c of the locking claw 43 contacts a lower surface of the annular portion 52, the second outer surface 43b contacts the inner circumference of the annular portion 52, and the locking claws elastically abut against the annular portion 52 with an elastic reactive force toward the inner circumference of the annular portion 52. Thereby, the locking portion 42 is locked in the locking hole 51.

When the locking claws abut against the annular portion 52, as shown in FIG. 4, the circumferential gap 63 is formed between the outer surface portion 41b and the inner circumference of the annular portion 52 around the locking hole 51 such that the fluid can be ventilated through the circumferential gap 63 from the inside to the outside. Therefore, in the check valve structure 10 of the embodiment, the hole plug 20 is made compact with maintaining flow efficiency of the fluid.

Further, in the hole plug of the modified embodiment shown in FIG. 5, the hole plug 20 has the protruding portion 46. Thereby, as shown in FIG. 8, the protruding portion 46 contacts an upper surface of the annular portion 52. Therefore, the annular portion 52 of the engaged portion 50 is sandwiched between the locking claw 43 and the protruding portion 46 of the hole plug 20, and the locking portion 42 is locked surely in the locking hole 51.

The protrusion 47, forming the protruding portion 46, may have a round shape portion at a front end thereof to easily support the annular portion 52.

In the hole plug of a modified embodiment shown in FIG. 5, since the hole plug 20 has the protruding portion 46, and the protruding portion 46 protrudes downwardly from the lower surface of the inner edge portion 35, when the locking portion 42 is inserted in the locking hole 51, as shown in FIG. 8, a circular gap 62 is circularly formed between the lower surface of the inner edge portion 35 and the upper surface of the annular portion 52 by an amount equal to the height of the protruding portion 46 in the protruding direction, in addition to the circumferential gap 63.

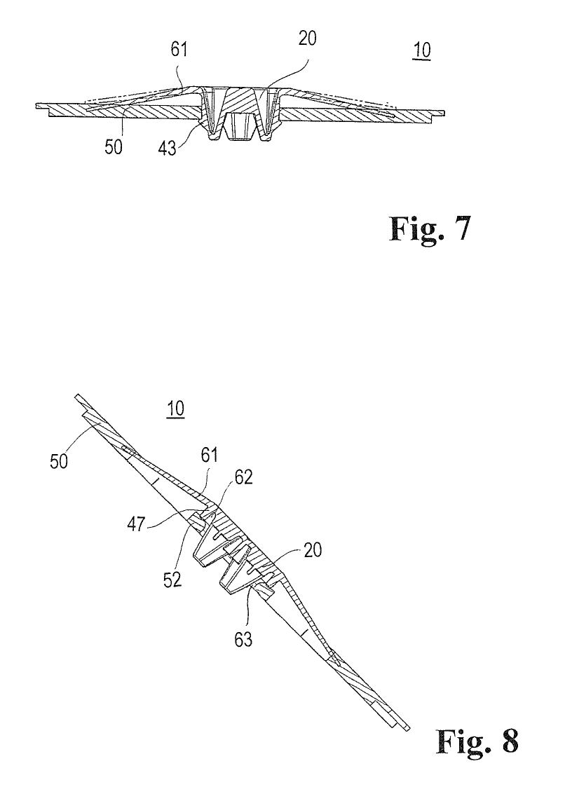

Since the circular gap 62 is communicated with the circumferential gap 63, the fluid can be ventilated through the circular gap 62 and the circumferential gap 63 from the inside to the outside. Also, the outer portion 21 includes a bendable portion 61 having a flexibility around the inner edge portion 35. When the locking portion 42 is inserted in the locking hole 51, the bendable portion 61 is bent by contacting the upper surface of the engaged portion 50. In the hole plug of the modified embodiment shown in FIG. 5, the bendable portion is bent as shown by the two-dot line in FIG. 7. However, the bendable portion 61 of the hole plug of the embodiment shown in FIG. 1 is bent same as the hole plug of the modified embodiment as well.

The outer portion 22 has an outer circumference larger than the ventilating holes 54 in a radial direction. Therefore, the outer portion 22 covers the ventilating holes 54, and the check valve structure 10 prevents the fluid and foreign materials, such as water and small particles, from flowing in a direction from the outside to the inside. The outer portion 22 may have an outer circumference substantially covering the ventilating hole; thereby, the hole plug 20 is made compact with maintaining flow efficiency of the fluid.

Further, in the hole plug of the modified embodiment shown in FIG. 5, since the protruding portion 46 is arranged on the lower surface of the inner edge portion 35, the bendable portion is formed around the inner edge portion 35. Therefore, a distance between an outer edge of the outer portion 22 and the protruding portion 46 becomes large. Thus, when fluid flows in a direction from the inside to the outside of the engaged portion 50, the outer portion 22 is easily bent at the bendable portion 61 in a direction apart from the engaged portion 50 to surely ventilate the fluid from the inside to the outside.

While the invention is explained with reference to the specific embodiment of the present invention, the explanation is illustrative and the invention is limited only by the appended claims.

What is claimed is:

1. A check valve structure comprising:
an engaged portion including a hole for ventilating fluid between one side and another side of the engaged portion, the hole including a locking hole and a ventilating hole outwardly circumferentially arranged around the locking hole; and
a hole plug including a locking portion inserted in the locking hole to lock the locking portion therein and an outer portion outwardly circumferentially extending from the locking portion to cover the ventilating hole such that the fluid flows in a direction from the one side to the another side, and is prevented from flowing in a direction from the another side to the one side.

2. A check valve structure according to claim 1, wherein the outer portion includes a bendable portion having flexibility and bent to vent the fluid from the one side to the another side.

3. A check valve structure according to claim 1, wherein the ventilating hole includes a plurality of holes, and has an outer circumference smaller than that of the outer portion.

4. A check valve structure according to claim 1, wherein the locking portion includes a plurality of locking pieces, each having a locking claw outwardly protruding from each of the plurality of locking pieces and engaging the engaged portion to form a gap therebetween such that the fluid is ventilated from the one side to the another side when the hole plug engages the engaged portion.

5. A check valve structure according to claim 4, wherein the plurality of locking pieces is spaced from each other to form a space therebetween, and the space is widened in a direction toward a bottom portion of each of the plurality of locking pieces.

6. A check valve structure according to claim 4, wherein the locking claw has elasticity to lock the locking portion in the locking hole.

7. A check valve structure according to claim 5, wherein the hole plug further comprises a protruding portion having a plurality of protrusions protruding from a lower surface of the outer portion, and the plurality of protrusions contacts the engaged portion outside the locking hole when the hole plug engages the engaged portion.

8. A check valve structure according to claim 6, wherein the plurality of locking pieces is arranged at a position not laterally overlapping with each of the plurality of protrusions.

9. A check valve structure according to claim 8, wherein the plurality of locking pieces is circularly arranged at equal intervals, and the plurality of protrusions is arranged circularly outside the plurality of locking pieces at equal intervals so that each of the plurality of protrusions is located between two of the locking claws, respectively.

10. A check valve structure according to claim 9, wherein each of the plurality of protrusions has a length in a protruding direction shorter than that of the locking claw.

11. A check valve structure according to claim 1, wherein the engaged portion is a panel, and the hole is formed in the panel.
